(19) United States
(12) Patent Application Publication
(10) Pub. No.: US 2005/0235095 A1
(43) Pub. Date: Oct. 20, 2005

(54) Write-once read-many hard disk drive using a WORM LBA indicator

(76) Inventors: Daniel James Winarski, Tucson, AZ (US); Robert George Emberty, Tucson, AZ (US); Craig Anthony Klein, Tucson, AZ (US); Nils Haustein, Zornheim (DE)

Correspondence Address: Allen K. Bates;IBM Corporation - 90A/9032-1, 9000 South Rita Road, Tucson, AZ, 85744, US

(21) Appl. No.: 10/825,146

(22) Filed: Apr. 14, 2004

(51) Int. Cl. G06F 12/08

(52) U.S. Cl. 711/4; 711/203; 711/156

(57) ABSTRACT

Disclosed are a system and method for writing WORM data to a data storage device by use of a WORM LBA indicator. A WORM memory is used to maintain an inventory of logical block addresses (LBAs) where WORM data is written on the data storage media of the data storage device. The WORM memory is a tamper proof memory device to maintain data integrity with respect to WORM data. Before writing any data to the disk the WORM memory for each LBA where data will be written is examined to determine if writing is allowed at the LBA. If writing is allowed, the data is written, otherwise no data is written.

### TECHNICAL FIELD

This invention relates to data recording information storage systems and methods related thereto. In particular, the invention relates to data recording disk drives and host computers having means for selectively and permanently disabling overwrite modes of the disk drives when the data written to these disk drives needs to be write-once, read-many (WORM).

### CROSS-REFERENCES TO RELATED APPLICATIONS

The present application is related to application Ser. No. ______, entitled “Write-Once Read-Many Hard Disk Drive Using A WORM Pointer”, Docket #TUC9-2004-0009, filed on an even date herewith, the disclosure of which is hereby incorporated by reference in its entirety.

### BACKGROUND

It is often necessary in computer data processing environments (from very small home computers to very large enterprise computers) to store data sets (e.g. data, program files, etc.) onto storage media in an archival format that cannot be altered. Write-Once Read Many (WORM) techniques using optical media are typically employed to provide this capability. Usually, these data sets are copied or moved to the optical media from a direct access storage device (DASD), such as a disk drive, as part of a migration, backup or archive operation. Many different types of rewritable storage media (e.g. hard disk drive, magnetic tape, optical disks, etc.) are used in data processing enterprises for space management and data backup operations. Space management includes data migration, which is the act of moving infrequently used data sets from primary storage to migration storage. Backing up is the act of periodically copying data sets, or portions thereof, from primary storage to backup storage in order to create one or more backup versions of the data sets which can be recovered following a disaster event. Rewritable storage media are often used for migration and backup because the data sets recorded thereon usually become obsolete, and the migration and backup disks can be reused to record new migration and backup data.

Data archival is the act of saving a specific version of a data set (e.g., for record retention purposes) for an extended period of time. The data set is placed in archive storage pursuant to command by a user or data processing administrator. Archived data sets are often preserved for legal purposes or for other reasons of importance to the data processing enterprise. It is therefore important that archived data volumes be capable of certification, meaning that automatic machine procedures are in place for certifying that the data sets written to the archive volume have not been altered or rewritten. There are some applications in which it is necessary or highly advantageous to provide a permanent, non-alterable version of a file. For example, legal documents, such as Securities and Exchange Commission (SEC) records, stock trading records, business dealings, e-mail, insurance records, etc. should be permanently stored on a media that cannot be altered once the files have been written to the storage device. Similar requirements for permanence exist for medical records and images. Traditionally, WORM functionality has been provided by ablative or alloy optical media used in optical disk drives.

Disks recorded according to WORM techniques, are often used for archival purposes because they can be written only once. There are at least two distinct methods being offered in the marketplace for WORM recording: WORM using ablative media, and Continuous Composite Write-once (CCW) using rewritable media, for example, magnetic tape. Ablative WORM disks are recorded using a high power laser beam which permanently ablates the media to form small pits which alter the reflectance of the media surface. When an incident laser beam (at a lower power level during read mode than during write operations) is focused on the media, there is produced an intensity modulated return beam containing the information recorded on the media. Ablative WORM thus provides a permanent audit trail of archived data based on the ablative nature of the recording media. In contrast, Continuous Composite Write-once (CCW) uses a rewritable media and a data storage drive that allows the rewritable media to be convertible from rewritable to read-only using drive firmware. Each media recording surface has a media descriptor table contained within a control track which defines the media as a unique media type. Previously manufactured drives will not recognize the media type, and therefore, will not read or write the media. The data on the media is therefore protected from being destroyed by such drives. There is also a storage state indicator within each sector of each track of the media that defines whether the sector is writable or read-only. When the indicator is in the “off” state the sector may be written. The writing process changes the state of the indicator to “on” or “read only,” which prevents any further writing on the sector. The problem with this CCW format is that a drive with altered microcode could easily ignore the logical WORM format indicator and freely rewrite the media. This rewritten media would appear as WORM when placed in a drive without altered microcode, and thus present data integrity issues.

Ablative WORM technology has been successfully marketed as superior to CCW technology due to the built-in tamper-resistant protection of the ablative media versus the perceived tamper protection offered by CCW drive firmware. However, the use of ablative technology has disadvantages with respect to the development time, development expense, and unit cost required for the drive and the media. Accordingly, a superior method is required for WORM data storage that reduces the substantial costs of ablative WORM yet provides greatly improved tamper resistance over CCW technology.

There is a need to provide such WORM functionality in a magnetic storage device, such as a hard disk drive (HDD) or a direct access storage device (DASD). One method of providing such functionality is to permit a manual change to the HDD such as setting an external switch or a jumper (pin or wire) to a write-inhibit position to prevent the magnetic storage media from being overwritten.. This method suffers from the drawback that the mechanism is easily reversed to make the media writable once again, because the switch or jumper could be temporarily reset to permit alteration of the data, and then reset back to the write-inhibit position. Such a solution is unsatisfactory for the typical WORM applications, which require the integrity of the saved data be maintained, where a true WORM function is required. Therefore, a need exists for secure WORM functionality in a magnetic hard disk drive.

### SUMMARY OF THE INVENTION

Broadly defined, the present invention provides a system and a method for writing WORM data to a data storage device. A WORM memory is used to maintain an inventory of logical block addresses (LBAs) where WORM data is written on the data storage media of the data storage device. The WORM memory is a tamper proof memory device to maintain data integrity with respect to WORM data. Before writing any data to the disk the WORM memory for each LBA where data will be written is examined to determine if writing is allowed at the LBA. If writing is allowed, the data is written, otherwise no data is written.

In method form, exemplary embodiments include a method for writing data on a data storage device, comprising: receiving a write command, obtaining a starting LBA and a LBA transfer length from the write command, using the starting LBA and the LBA transfer length to determine one or more destination LBAs for writing data to, obtaining a LBA WORM utilization bit from a WORM memory for each of the destination LBAs and in response to the LBA WORM utilization bit indicating a rewriteable LBA for each of the destination LBAs, executing the write command to write data to the destination LBAS.

In system embodiments the present invention provides a data storage device, comprising: a data storage media for storage of data; a processor for controlling the data storage device; a WORM memory coupled to the processor for storage of a LBA WORM utilization bit; and a host device interface coupled to the processor for receiving commands from a host computer.

For a fuller understanding of the nature and advantages of the present invention, reference should be made to the following detailed description taken together with the accompanying drawings.

### BRIEF DESCRIPTION OF THE DRAWINGS

FIG. 1 shows a side view of a hard disk drive;

FIG. 2 shows a top view of a hard disk drive;

FIG. 3 shows the control circuitry of a hard disk drive;

FIG. 4 shows a computer system utilizing a hard disk drive;

FIG. 5 shows a typical format of a disk surface of a hard disk drive;

FIG. 6 shows a table of the format of a disk surface;

FIG. 7 shows an exemplary write command for writing data to a data storage device;

FIG. 8 shows a flowchart of the process for the writing of WORM data on a data storage device; and

FIG. 9 shows an example of LBAs and the contents of a WORM memory.

### DETAILED DESCRIPTION OF PREFERRED EMBODIMENTS

In the preferred embodiment a magnetic disk drive (also referred to as a disk drive or hard disk drive (HDD)) is used to implement the present invention. Accordingly, the following description will proceed with reference to a magnetic disk drive. The use of a disk drive to describe the operation of the present invention does not preclude the use of the present invention on other data storage devices (e.g. optical data storage, magnetic tape, etc.).

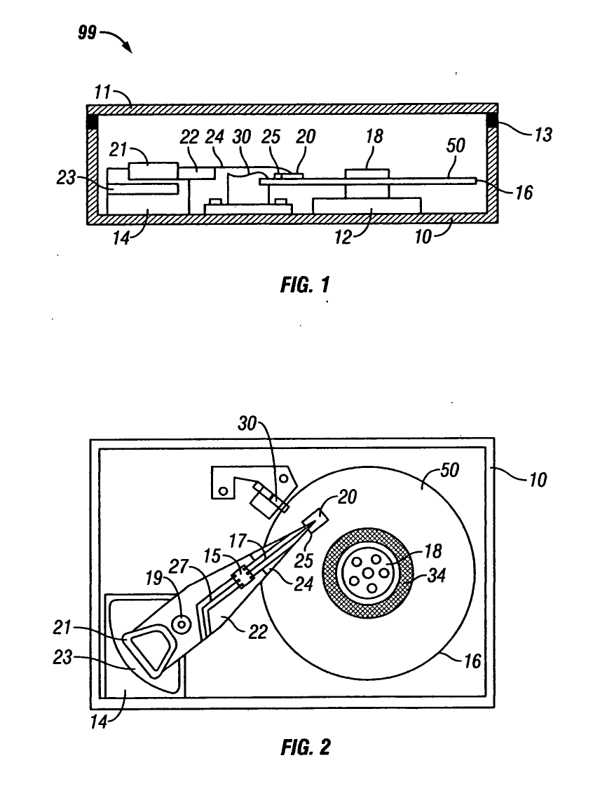

Referring first to FIG. 1, there is illustrated in sectional view a schematic of a disk drive 99 according to the present invention. For ease of illustration and explanation, the disk drive 99 depicted in FIGS. 1 and 2 is shown as having a single recording head and associated disk surface, although conventional disk drives typically have multiple heads, one on each side of multiple disks and the present invention applies equally to both multiple disk/head and single disk/head drives.

The disk drive 99 comprises a base 10 to which are secured a spindle motor 12, an actuator 14 and a cover 11. The base 10 and cover 11 provide a substantially sealed housing for disk drive 99. Typically, there is a gasket 13 located between base 10 and cover 11. A small breather port (not shown) for equalizing the air pressure between the interior of disk drive 99 and the outside environment is typically placed in a base 10 of larger HDDs. Smaller HDDs, such as the HDDs used in laptops and notebooks, may not need this small breather port due to the tiny amount of free cavity volume in smaller HDDs. This type of disk drive is described as being substantially sealed because the spindle motor 12 is located entirely within the housing and there is no external forced air supply for cooling the interior components. A magnetic recording disk 16 is connected to spindle motor 12 by means of spindle or hub 18 for rotation by spindle motor 12. A thin film 50 of lubricant is maintained on the surface of disk 16. Recording disk 16 is the data storage media for storage of data for disk drive 99. In alternative embodiments, the data storage media may comprise, for example, magnetic tape, optical storage media, etc., without limitation.

A read/write head or transducer 25 is formed on the trailing end of an air-bearing slider 20. Transducer 25 typically has an inductive write transducer and either a magnetoresistive (MR) or a giant magnetoresistive (GMR) read transducer, all of which are formed by thin-film deposition techniques as is known in the art. The slider 20 is connected to the actuator 14 by means of a rigid arm 22 and a flexible suspension 24, the flexible suspension 24 providing a biasing force which urges the slider 20 towards the surface of the recording disk 16. The arm 22, flexible suspension 24, and slider 20 with transducer 25 are referred to as the head-slider-arm (HSA) assembly.

During operation of disk drive 99, the spindle motor 12 typically rotates the disk 16 at a constant angular velocity (CAV), and the actuator 14 pivots on shaft 19 to move slider 20 in a gentle arc that is aligned generally radially across the surface of disk 16, so that the read/write transducer 25 may access different data tracks on disk 16. The actuator 14 is typically a rotary voice coil motor (VCM) having a coil 21 that moves in an arc through the fixed magnetic field of magnet assembly 23 when current is applied to coil 21. Alternately, arm 22, flexible suspension 24, slider 20, and transducer 25 could move along a radial line via a linear VCM (not shown).

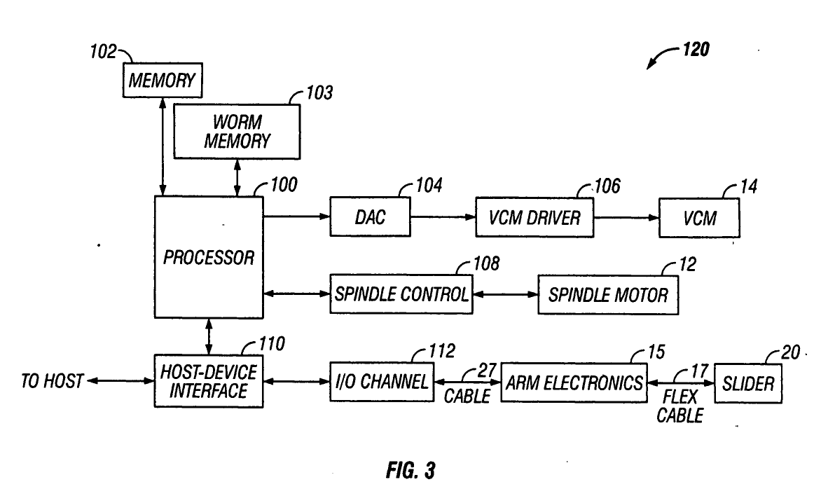

FIG. 2 is a top view of the interior of disk drive 99 with the cover 11 removed, and illustrates in better detail flexible suspension 24 which provides a force to the slider 20 to urge it toward the disk 16. The suspension may be a conventional type of suspension such as the well-known Watrous suspension, as described in U.S. Pat. No. 4,167,765. This type of suspension also provides a gimbaled attachment of the slider 20 that allows the slider 20 to pitch and roll as it rides on the air bearing. The data detected from disk 16 by transducer 25 is processed into a data readback signal by an integrated circuit signal amplification and processing circuit in arm electronics (AE) 15, located on arm 22. The signals between transducer 25 and arm electronics 15 travel via flex cable 17. The signals between arm electronics 15 and I/O channel 112 of FIG. 3 travel via cable 27. Arm 22 rotates about pivot 19. When I/O is completed, actuator 14 may rotate slider 20 toward the inner diameter of disk 16 and park slider landing zone 34. Landing zone 34 is typically rougher than the remainder of disk 16, to mitigate stiction between slider 20 and disk 16 when disk drive 99 is spun up to speed after a power-down period of time. Alternately, load/unload ramp 30, which is mounted to the base 10, contacts suspension 24 and lifts the slider 20 away from disk 16 when the actuator 14 rotates the slider 20 toward the disk outside diameter when disk drive 99 is powered down. When disk drive 99 is spun back up to speed after a power-down period of time, actuator 14 either moves slider off of landing zone 34 or load/unload ramp 30 and onto the data area of disk 16.

Referring now to FIG. 3, drive electrical components include a processor 100 that processes instructions contained in memory 102 to control disk drive 99. Processor 100 may comprise an off-the-shelf processor, custom processor, FPGA (Field Programmable Gate Array), ASIC (Application Specific Integrated Circuit), discrete logic, etc. Memory 102 is used to hold variable data, stack data, and executable instructions. Memory 102 is preferably RAM (Random Access Memory). Processor 100 is coupled to and accesses WORM memory 103, wherein a LBA WORM utilization bit is stored. The WORM memory 103 is preferably EPROM (Erasable Programmable Read Only Memory). EPROMs are typically erased with UV light. In the preferred embodiment, WORM memory 103 is located inside of disk drive 99 to prevent the erasure of worm pointer memory 103 without mechanically opening sealed disk drive 99. Alternatively, WORM memory 103 may be located inside a sealed portion of a data storage device to further provide tamper resistance. The sealed portion of the data storage device may require special tooling, breakage of seals, etc. to clearly indicate any possible tampering of WORM memory 103. Additionally, WORM memory 103 may comprise PROM (Programmable Read Only Memory), FLASH or EEPROM. FLASH is a form of EEPROM (Electrically Erasable Programmable Read Only Memory). EEPROM may be erased one byte at a time, whereas FLASH must be erased in blocks. Because of its block-oriented nature and the fixed block architecture of hard disk drives, FLASH memory is commonly used as a supplement to or replacement for hard disk drives in portable computers.

Processor 100 sends digital signals to digital-to-analog converter (DAC) 104, for conversion to low-power analog signals. These low-power analog signals are received by VCM driver 106. VCM driver 106 amplifies the low-power analog signals into high-power signals to drive VCM 14. Processor 100 also controls and is connected to the spindle motor 12 via spindle controller 108. VCM 14 is energized by the VCM driver 106 which receives analog voltage signals from DAC 104. VCM driver 106 delivers current to the coil 21 of VCM 14 in one direction to pivot the head-slider-arm assembly radially outward and in the opposite direction to pivot the head-slider-arm assembly radially inward. The spindle controller 108 controls the current to the armatures of spindle motor 12 to rotate the motor at a constant rotational speed, which is also known as constant angular velocity or CAV, during drive operation. In addition, the spindle controller 108 provides a status signal to processor 100 indicating whether or not spindle motor 12 is rotating at its operating speed via the back electromotive force (BEMF) voltage from spindle motor 12, which will have a nonzero value when motor 12 is rotating. Spindle motor 12 is commonly a brushless DC motor with three windings or three sets of windings.

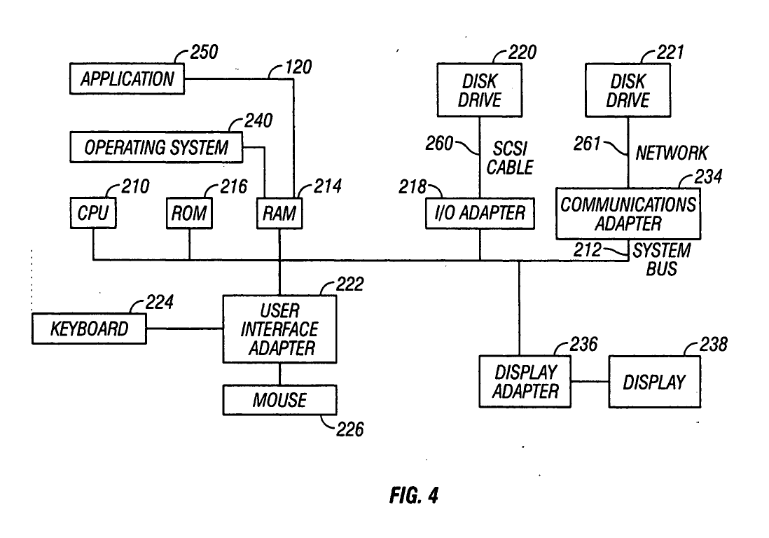

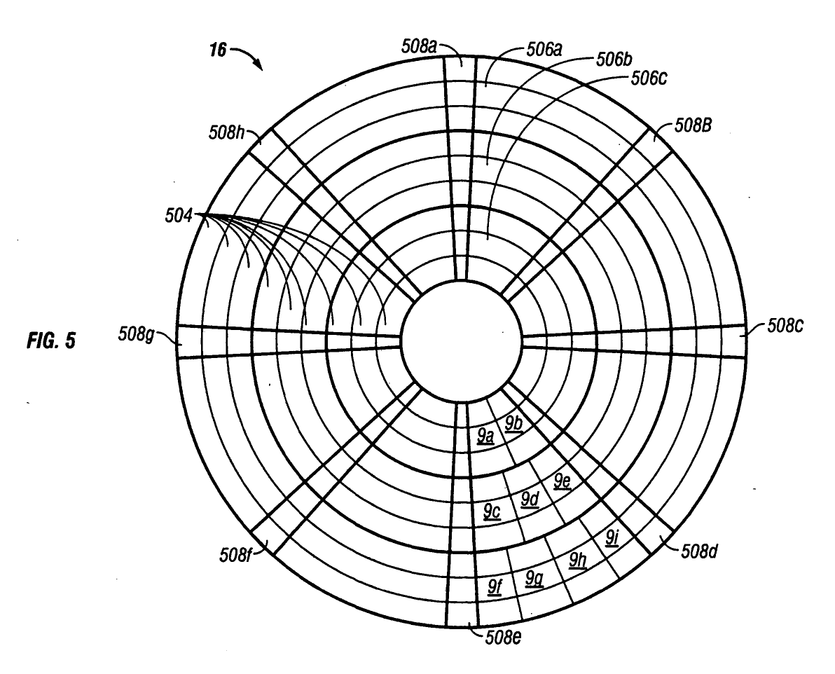

Host-device interface 110 is coupled to and communicates with processor 100 to send and receive commands with respect to host computer 120. Additionally, host-device interface 110 receives data from host computer 120 (FIG. 4) and sends it to I/O channel 112, where the data is encoded before being sent via cable 27 to arm electronics 15. Typical encoding is via a convolution encoder. From arm electronics 15, the encoded data is sent via flex cable 17 to the inductive write transducer on slider 20 resulting in the encoded data being written to disk 16. Similarly, when data is requested by host computer 120, the MR or GMR read transducer on slider 20 reads the encoded data off of disk 16, and sends that data to arm electronics 15 via flex cable 17. From arm electronics 15, the encoded data is sent via cable 27 to be decoded by I/O channel 112 before being sent to host computer 120 via host-device interface 110. A typical decoder is a PRML (partial-response, maximum likelihood) decoder.

FIG. 4 illustrates a typical hardware configuration of a host computer 120 utilizing the hard disk drive shown in FIGS. 1 and 2. Although the following description will proceed with reference to a host computer to describe the operation of the present invention, this does not preclude the use of the present invention on other devices (e.g. personal computer, server, storage controller, storage server, automated data storage library, virtual tape server, etc.) that may interface to hard disk drives or other data storage devices (e.g. optical data storage, magnetic tape, etc.). Any reference herein to a host computer includes, without limitation, the previously mentioned devices that may interface to hard disk drives or other data storage devices.

Host computer 120 has a central processing unit (CPU) 210 coupled to various other components by system bus 212. An operating system 240, runs on CPU 210 and provides control of host computer 120 and the attached hard disk drives 220 and 221. Disk drives 220 and 221 may each comprise one or more disk drives 99 to provide a data storage device to host computer 120. Keyboard 224 and mouse 226 are connected to system bus 212 via user interface adapter 222.

Read only memory (ROM) 216 is coupled to system bus 212 and includes a basic input/output system (BIOS) that controls certain functions of computer 120. Random access memory (RAM) 214, I/O adapter 218, and communications adapter 234 are also coupled to system bus 212. It should be noted that software components including operating system 240 and application 250 are loaded into RAM 214, which is the main memory of computer 120. I/O adapter 218 and communications adapter 234 are two examples of data storage device interfaces that may be used to interface and couple disk drives 220, 221 to host computer 120. I/O adapter 218 may be a small computer system interface (SCSI) adapter. SCSI cable 260 is connected between I/O Adapter 218 and Host-Device Interface 110 of FIG. 3 so that host computer 120 communicates with disk drive 220. Similarly, communications adapter 234 communicates with Network Attached Storage (NAS) disk drive 221 via network 261. Communications adapter 234 may be an Ethernet, Fiber Channel, ESCON, FICON, Wide Area Network (WAN), or TCP/IP interface. Additionally, other embodiments of data storage device interfaces, cables, protocols, etc., may be used to interface and couple disk drives 220, 221 to host computer 120, either using host device interface 110 or another equivalent interface, without limitation. A display monitor 238 is connected to system bus 212 by display adapter 236. In this manner, a user is capable of receiving visual messages concerning the disablement of the write-mode of disk drives 220 and 221.

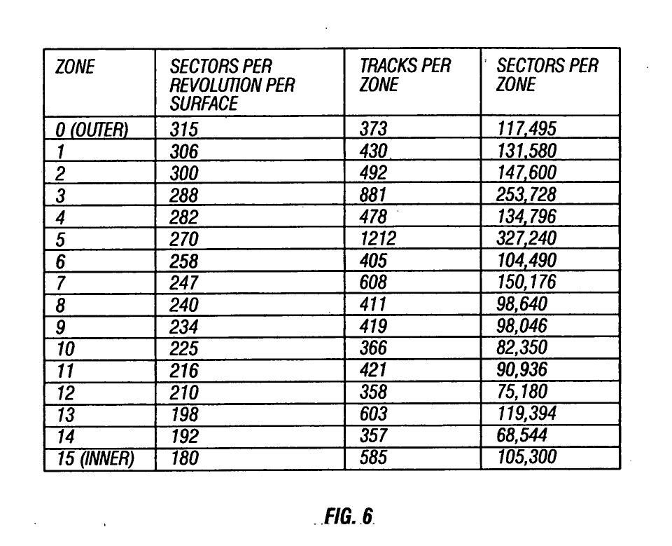

FIG. 5 illustrates an arrangement of a recording surface of disk 16 divided into concentric circular “tracks” on the disk surface. Disk 16 rotates at a constant angular velocity (CAV). It is divided up into data zones 506a, 506b, and 506c, so the overall format of disk 16 is zoned constant angular velocity (ZCAV). Each zone is divided into data sectors laid out on concentric tracks 504. Alternately, spiral tracks may be used. In a given angular region, outer zone 506a has data sectors 9f, 9g, 9h, and 9i; middle zone 506b has data sectors 9c, 9d, and 9e; and inner zone 506c has data sectors 9a and 9b. A logical block address (LBA) is used to address a specific data sector 9a-9h. A data sector is the smallest logical unit that can be accessed on the disk. The size of a data sector is typically 512 bytes. As can be seen in FIG. 5, there are more data sectors per track in the outer zones than in the inner zones. This is better shown in FIG. 6. Processor 100 (FIG. 3) maps the LBA locations for disk drive 99 from information stored in memory 102 that is equivalent to that shown in FIG. 6. FIG. 5 also shows servo sectors 508a-h on disk 16.

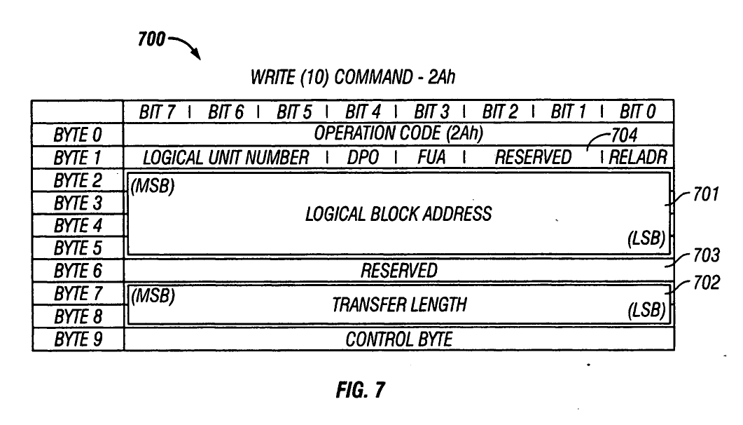

Commands are transmitted and received between host computer 120 and disk drives 220, 221 in a bidirectional manner to facilitate reading and writing data. Various communication interfaces and protocols may be used without limitation for the present invention, for example, SCSI commands. An example of a write command is the WRITE command 700 is shown in FIG. 7. WRITE command 700 includes a starting LBA address 701 of the command and a transfer length 702. For FBA (fixed block length) addressing, transfer length 702 is in multiples of the fixed block length, which is identical to an incremental LBA transfer length. The block length for a typical hard disk drive is 512 bytes, which is called a FBA. Partial blocks are not written, therefore the transfer length is in multiples of 512 bytes. Thus, the last LBA written is the sum of the starting LBA address 701 and the incremental LBA transfer length 702. Processor 100 maps the LBA to a specific data position (physical sector) on one of the disk surfaces. In this example, the LBA's are preferably mapped in tracks, shown in FIG. 5, and cylinders. Cylinders are logically formed from similar tracks on each data surface (of multiple disks) in hard disk drive 99, to enable data to be written on the similar tracks of different disk surfaces via head switching rather than seeking, as head switching is often faster than seeking.

FIG. 6 comprises a table showing the number of sectors per track, tracks per zone, and sectors per zone, per disk recording surface, for fifteen different zones, numbered from zero for the outermost zone to the highest number zone 15, which is the innermost zone. The second column shows that the outermost zones have a higher number of sectors per disk revolution than the inner zones, as the tracks in the outermost zones have a greater circumference, thereby allowing more sectors than the inner zones. The third column shows the number of tracks in a zone. Multiplying the second and third columns provides the sectors per zone as shown in the fourth column. The number of sectors of an inner zone may exceed the sectors in an outer zone, if the inner zone includes more tracks than the outer zone.

Processor 100 accesses memory 102 to obtain the information necessary (illustrated in FIG. 6), to locate a specific LBA. Starting at outer zone 0, the processor 100 uses the number of sectors per revolution (or sectors per track) and the number of tracks in that zone to locate a specific LBA. For example, if the desired LBA is located within zone 0, processor 100 may implement a procedure to divide the LBA by the sectors per revolution and the number of surfaces to obtain the number of tracks to traverse or seek across. The remainder of this first division must be divided by the number of sectors per revolution to give the destination disk surface. The remainder of this second division minus one gives the number of sectors to skip over in that destination track in order to reach the desired LBA. For example, to start writing at LBA 207, on a disk drive with 2 surfaces (1 disk) the following procedure could be used. In this first zone, there are 30 sectors per track and performing the division of 207/30, results in 6+27/30. Thus, 6 complete tracks are bypassed, 3 tracks on each of the 2 surfaces. The writing begins on LBA 27 of the 7^{th} track, which is the 4^{th} track on surface 0.

A read or a write command, such as WRITE SCSI command 700 shown in FIG. 7, includes a starting LBA address 701 of the command and a transaction length 702. For FBA (fixed block length) addressing, transaction length 702 is in multiples of the fixed block length, which is identical to an incremental LBA transfer length. Thus, the last LBA written is the sum of the starting LBA address 701 and the incremental LBA transaction length 702. A WORM bit may be stored in either of the reserved and presently unused fields 703 or 704. In the preferred embodiment field 703 is used because it represents an entire unused byte. Alternatively, field 704 may be used for the location of the WORM bit. If the WORM bit has the value of zero in fields 703 or 704, then the WORM bit is considered “off” and the data to be written is rewritable. However, if the WORM bit has the value 1 in either of fields 703 or 704, then the WORM bit is considered “on” and the data is to be written as write-once, read many.

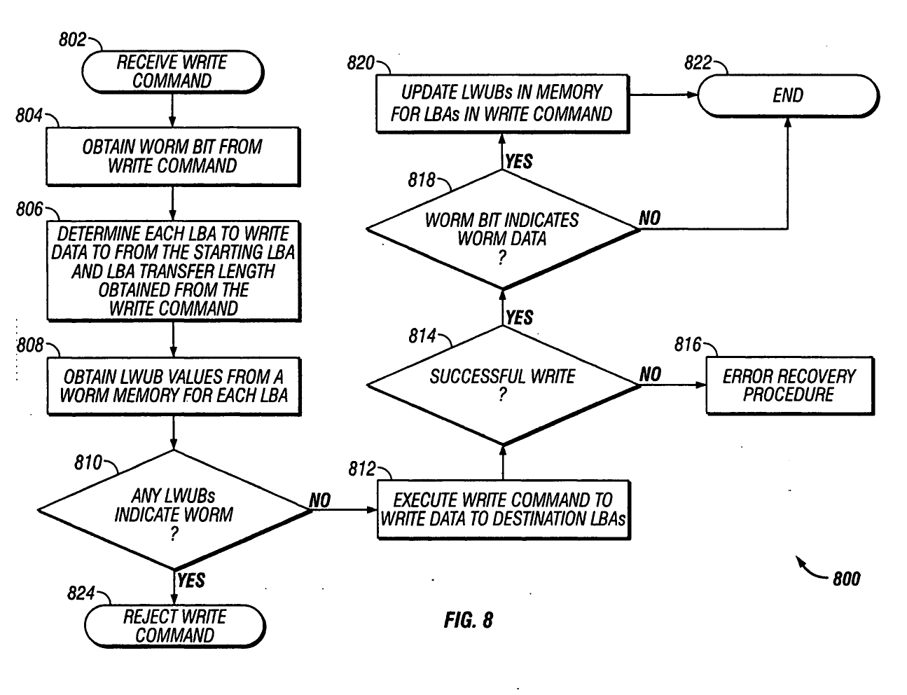

FIG. 8 shows flowchart 800 that describes one example of a process for writing WORM data to the disk 16. Algorithm 800 begins with step 802, where a write command is received from a host(s) by disk drive 99, for example, disk drive 220 or 221. Before disk drive 99 receives the write command a series of commands from the host and responses from disk drive 99 may be executed to prepare disk drive 99 for the write command. After disk drive 99 receives the write command, the process flows to step 8046, where a WORM bit is obtained from the received write command. An example of a write command for use with the present invention is shown in FIG. 7. The process flows to step 806, where the LBAs to be written are determined. Each LBA to write data to may be referred to as destination LBAs. The WORM bit determined in step 8042 applies to all LBAs specified in the write command. These LBAs to be written are typically determined by the starting logical block address 701 in WRITE command 700 of FIG. 7 and the transfer length in LBAs, 702 in command 700. To determine the destination LBAs a starting LBA and a LBA transfer length are obtained from the received write command. Each LBA to write data to begins at the starting LBA and includes all LBAs up to the sum of the LBA transfer length and the starting LBA. The process then flows to step 808, where the LWUB (LBA-WORM Utilization Bit) is retrieved from WORM memory 103 for each LBA to write data to. In this way all LWUBs are obtained for each LBA to write data to (i.e. destination LBAs). WORM memory 103 contains and entry for every LBA on the surface of disk 16. WORM memory 103 may be accessed by processor 100 to obtain the respective LWUB for any LBA on disk 16. The values of the memory location for each LBA may be a 1 or a 0. An assignment may be made were a value of 1 may indicate that the LBA is WORM and a value of zero for the LWUB may indicate the LBA is rewritable. Other assignments may be used without limitation. For this assignment, the default setting for all LWUBs is zero, resulting in disk drive 99 being entirely rewritable unless programmed otherwise by use of the LWUB.

The process then flows to decision step 810, where a determination is made whether any of the LWUBs for the destination LBAs indicate that the LBA is WORM. If the determination in step 810 is that the LBA WORM utilization bit indicates a WORM LBA for any of the destination LBAs, the write command is not executed. The result is that the process rejects the write command at step 824 because the host issuing the write command is attempting to rewrite data in the WORM area of the disk drive. If the determination in step 810 is that the LBA WORM utilization bit indicates a rewriteable LBA for all of the destination LBAs, then the write command is executed to write data to the destination LBAs. The result is that the process flows to step 812 where the data is written to disk drive 99. The process then flows to decision step 814, where the determination is made whether the write was successful. This determination could be made by performing a write-verification procedure or if no errors occurred upon executing the write command or a combination thereof. One example of a write-verification procedure is to read back the data written and compare it to the original data. If the determination is that the write was not successful in step 814, for example, if at least one error occurred upon executing the write command, then the process flows to error recovery step 816. The error recovery could consist of a procedure to attempt to rewrite the data in the exact same location (beginning at the starting LBA) as specified by the original write command. If the rewrite failed at the exact same location, then the host could increment the starting LBA to be the first LBA after where the data could not be written or any LBA greater than the starting LBA.

If the determination is that the write was successful in step 814, the process flows to step 818, where the value of the WORM bit obtained from the write command is examined. If the write command executed without errors and the WORM bit indicates WORM data, then the LBA WORM utilization bit for each LBA to write data to in the WORM memory is set to indicate WORM data. For example, if the WORM bit has the value of one indicating WORM data, the process flows to step 820 where the LWUBs associated with the LBAs that were written to (i.e. destination LBAs) are changed to one, to indicate WORM LBAs.

Each time WORM data is written to disk drive 99, new values for the LBA WORM utilization bit for the destination LBAs are stored in WORM memory 103, by for example, processor 100. Once stored, each LBA WORM utilization bit cannot be altered from WORM to rewriteable. The result is that an audit trail is created showing the starting LBA of each data set stored as WORM on the recording surface of disk 16. In addition, a date stamp may be also stored in conjunction with each LBA WORM utilization bit entry to further provide a record of data storage. The date stamp could comprise the date and time that each LBA WORM utilization bit is written to memory to provide further confirmation of valid WORM data for audit purposes. The date stamp could be provided from a real time clock associated with processor 100, host computer, etc. The date stamp could be stored in WORM memory 103, or another memory device associated with disk drive 99. The memory device for the date stamp storage may be in a sealed portion of disk drive 99 or other measures may be used to ensure that the date stamp may not be altered. After execution of step 818, the process then flows from step 820 to end at step 822. If the determination at step 818 is that the WORM bit does not indicate WORM, the process flows to end step 822 and the data written is rewritable as the LWUBs associated with those LBAs remain zero.

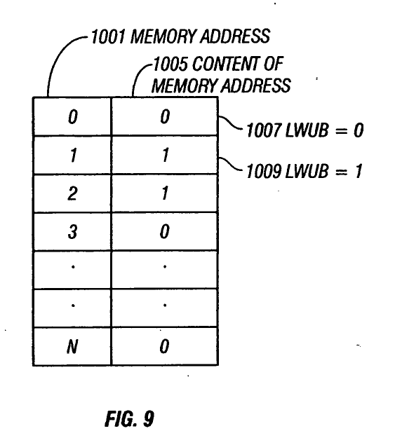

FIG. 9 shows and example of the possible contents of WORM memory 103. The left hand column represents a memory address 1001 and the right hand column represents the content of memory address 1005. Each memory address 1001 corresponds to an LBA on disk 16. At each memory address 1001 is stored a LWUB for the corresponding LBA. For example, LWUB 1007 is equal to zero indicating that the LBA is rewriteable and LWUB 1007 is equal to 1 indicating that the LBA is WORM. A further use of the LWUB is that LBAs on the disk 16 having an associated LWUB value that indicates WORM in WORM memory 103 cannot be erased or reformatted. Furthermore, all further writing is prohibited to those LBAs, including write, write-verify, and SCSI long write commands.

The invention disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

While the preferred embodiments of the present invention have been illustrated in detail, it should be apparent that modifications and improvements may be made to the invention without departing from the spirit and scope of the invention. For example, the data could be alternately be stored holographically, magneto-optically, or on phase-change optical media. All of these alternate media are reversible or rewritable. This invention would apply to all of these media as long as WORM memory 103 was stored in an area not accessible to the customer, such as enclosed inside of a sealed container such as shown in FIGS. 1 and 2.

1. A method for writing data on a data storage device, comprising:
said data storage device receiving a write command;
obtaining a starting LBA and a LBA transfer length from said write command;
using said starting LBA and said LBA transfer length to determine one or more destination LBAs for writing data to;
obtaining a LBA WORM utilization bit from a WORM memory for each of said one or more destination LBAs; and
in response to said LBA WORM utilization bit indicating a rewriteable LBA for each of said one or more destination LBAs, executing said write command to write data to said one or more destination LBAs.

2. The method of claim 1, further comprising:
in response to said LBA WORM utilization bit indicating a WORM LBA for any of said one or more destination LBAs, not executing said write command.

3. The method of claim 1, further comprising:
obtaining a WORM bit from said write command; and
in response to determining that said write command executed without errors and that said WORM bit indicates WORM data, setting said LBA WORM utilization bit for said one or more destination LBAs in said WORM memory to indicate WORM data.

4. The method of claim 1, further comprising:
in response to determining that said write command executed with at least one error, rewriting said data.

5. The method of claim 1, further comprising:
in response to determining that said write command executed with at least one error, rewriting the data beginning at said starting LBA.

6. The method of claim 1, further comprising:
in response to determining that said write command executed with at least one error, rewriting said data beginning at a LBA that is greater than said starting LBA.

7. The method of claim 1, wherein said write command writes said data as WORM data on said data storage device.

8. A data storage device, comprising:
a data storage media for storage of data;
a processor for controlling said data storage device;
a WORM memory coupled to said processor for storage of a LBA WORM utilization bit; and
a host device interface coupled to said processor for receiving commands from a host computer.

9. The data storage device of claim 8, wherein said data is stored as WORM data on said data storage media.

10. The data storage device of claim 8, wherein said processor obtains a starting LBA and a LBA transfer length from a write command received by said host device interface, uses said starting LBA and said LBA transfer length to determine one or more destination LBAs for writing data to, obtains a LBA WORM utilization bit from a WORM memory for each of said one or more destination LBAs and in response to said LBA WORM utilization bit indicating a rewriteable LBA for each of said one or more destination LBAs, executes said write command to write data to said one or more destination LBAs.

11. The data storage device of claim 8, wherein said WORM memory is an EPROM.

12. The data storage device of claim 8, wherein said WORM memory is a PROM.

13. The data storage device of claim 8, wherein said WORM memory is a FLASH memory.

14. The data storage device claim 8, wherein said WORM memory is located inside a sealed portion of said data storage device.

15. The data storage device claim 8, wherein said WORM memory, further comprises:
a memory device for storage of a date stamp associated with each said LBA WORM utilization bit.

16. An article of manufacture comprising a data storage medium tangibly embodying a program of machine-readable instructions executable by a digital processing apparatus to perform method steps for writing data on a data storage device, said steps comprising:
said data storage device receiving a write command;
obtaining a starting LBA and a LBA transfer length from said write command;
using said starting LBA and said LBA transfer length to determine one or more destination LBAs for writing data to;
obtaining a LBA WORM utilization bit from a WORM memory for each of said one or more destination LBAs; and
in response to said LBA WORM utilization bit indicating a rewriteable LBA for each of said one or more destination LBAs, executing said write command to write data to said one or more destination LBAs.

17. The article of manufacture of claim 16, wherein said method steps further comprises:
in response to said LBA WORM utilization bit indicating a WORM LBA for any of said one or more destination LBAs, not executing said write command.

18. The article of manufacture of claim 16, wherein said method steps further comprises:
obtaining a first WORM bit from said write command; and
in response to determining that said write command executed without errors and that said first WORM bit indicates WORM data, setting said LBA WORM utilization bit for said one or more destination LBAs in said WORM memory to indicate WORM data.
